(19) United States
(12) Patent Application Publication
(10) Pub. No.: US 2026/0259451 A1
(43) Pub. Date: Sep. 3, 2026

(54) BACKLIGHT SOURCE AND DISPLAY DEVICE

(71) Applicants: BEIJING BOE TECHNOLOGY DEVELOPMENT CO., LTD., Beijing (CN); BOE TECHNOLOGY GROUP CO., LTD., Beijing (CN)

(72) Inventor: Yanliu SUN, Beijing (CN)

(21) Appl. No.: 18/875,311

(22) PCT Filed: Aug. 21, 2023
(86) PCT No.: PCT/CN2023/114017

§ 371 Date: Dec. 16, 2024

(51) Int. Cl. G02F 1/1335; G02F 1/13357

(52) U.S. Cl. CPC G02F 1/133607; G02F 1/133603; G02F 1/133611

(57) ABSTRACT

A backlight source and a display device are provided. In the backlight source, a light source includes light-emitting units; a light-transmitting substrate is located at a light-emitting side of the light source; a first lens group includes first lenses and is located at a light-exit side of the light-transmitting substrate, and a second lens group includes second lenses and is located at a light incident side of the light-transmitting substrate. Largest dimensions of the first lens and the second lens is respectively a first dimension and a second dimension, and the first dimension is greater than the second dimension. A largest dimension of each light-emitting unit is a third dimension, a ratio of the second dimension to the third dimension ranges from 0.2 to 0.5, and a ratio of the second dimension to the first dimension ranges from 0.04 to 0.2.

### TECHNICAL FIELD

The present disclosure relates to a backlight source and a display device.

### BACKGROUND

Virtual Reality (VR) display is gradually becoming a hot field. In order to reduce the graininess of the display screen, the resolution of the display screen is generally greater than 1500 ppi, or even higher, such as greater than 3000 ppi. For a display screen with such a high pixel per inch (ppi), the pixel transmittance will decrease seriously, for example, the pixel transmittance of a display screen applied to a virtual reality display device is generally lower than 2%, which directly leads to the increase of backlight brightness and even the increase of the overall power consumption of the module.

### SUMMARY

The present disclosure provides a backlight source and a display device.

The present disclosure provides a backlight source includes a light source, a light-transmitting substrate, a first lens group, and a second lens group. The light source includes a plurality of light-emitting units; the light-transmitting substrate is located at a light-emitting side of the light source; the first lens group is located at a light-exit side of the light-transmitting substrate, and the first lens group includes a plurality of first lenses; the second lens group is located at a light incident side of the light-transmitting substrate, and the second lens group includes a plurality of second lenses. A largest dimension of each first lens in a direction parallel to the light-transmitting substrate is a first dimension, a largest dimension of each second lens in the direction parallel to the light-transmitting substrate is a second dimension, and the first dimension is greater than the second dimension, and an orthographic projection of at least one second lens on the light-transmitting substrate overlaps with an outline of an orthographic projection of at least one first lens on the light-transmitting substrate or is located in an interval between orthographic projections of adjacent first lenses on the light-transmitting substrate; a largest dimension of each light-emitting unit in the direction parallel to the light-transmitting substrate is a third dimension, a ratio of the second dimension to the third dimension ranges from 0.2 to 0.5, and a ratio of the second dimension to the first dimension ranges from 0.04 to 0.2.

For example, according to an embodiment of the present disclosure, a ratio of the first dimension to a pitch of adjacent light-emitting units ranges from 0.7 to 1.3.

For example, according to an embodiment of the present disclosure, a distance between an optical axis of at least one first lens and an optical axis of a second lens closest to the optical axis of the at least one first lens is less than 15 microns.

For example, according to an embodiment of the present disclosure, the plurality of first lenses are arranged in one-to-one correspondence with the plurality of light-emitting units, an orthographic projection of each first lens on the light-transmitting substrate overlaps with orthographic projections of at least two second lenses on the light-transmitting substrate, and an optical structure is formed by the first lens, the light-transmitting substrate and the at least two second lenses, with their orthographic projections overlapping, and a distance between at least one light-emitting unit and a focal plane of its corresponding optical structure is not more than 50 microns.

For example, according to an embodiment of the present disclosure, the plurality of first lenses are closely arranged and the plurality of second lenses are closely arranged.

For example, according to an embodiment of the present disclosure, a shape of an orthographic projection of each first lens on the light-transmitting substrate includes a hexagonal shape, there is essentially no gap between the orthographic projections of the adjacent first lenses on the light-transmitting substrate, and the orthographic projection of the at least one second lens on the light-transmitting substrate overlaps with outlines of orthographic projections of at least two first lenses on the light-transmitting substrate.

For example, according to an embodiment of the present disclosure, a shape of an orthographic projection of each first lens on the light-transmitting substrate includes a circle, a gap between orthographic projections of any adjacent first lenses on the light-transmitting substrate overlaps with the orthographic projection of the at least one second lens on the light-transmitting substrate.

For example, according to an embodiment of the present disclosure, a shape of an orthographic projection of each first lens on the light-transmitting substrate includes a circle, a gap is between orthogonal projections of any adjacent first lenses on the transparent substrate, the orthographic projection of the at least one second lens on the light-transmitting substrate is completely located within the gap.

For example, according to an embodiment of the present disclosure, a geometric center of the gap falls within an orthographic projection of one second lens on the light-transmitting substrate, and the orthographic projection of the one second lens on the light-transmitting substrate is completely located within the gap.

For example, according to an embodiment of the present disclosure, a geometric center of the gap falls within an orthographic projection of one second lens on the light-transmitting substrate, and the orthographic projection of the one second on the light-transmitting substrate overlaps or tangents with an orthographic projection of the first lens on the light-transmitting substrate.

For example, according to an embodiment of the present disclosure, each light-emitting unit is configured to emit white light.

For example, according to an embodiment of the present disclosure, at least one light-emitting unit includes sub light-emitting units of different colors.

For example, according to an embodiment of the present disclosure, a ratio of a thickness of the light-transmitting substrate to a largest dimension of the second lens in a direction perpendicular to the light-transmitting substrate ranges from 8 to 20.

For example, according to an embodiment of the present disclosure, the first lens includes a plano-convex lens and the second lens includes a plano-convex lens, and a plane of the first lens and a plane of the second lens both face the light-transmitting substrate.

For example, according to an embodiment of the present disclosure, the first lens and the second lens each include a spherical lens.

For example, according to an embodiment of the present disclosure, a ratio of a radius of curvature of the first lens to the first dimension ranges from 0.4 to 0.6, and a ratio of the first dimension to a largest dimension of the first lens in a direction perpendicular to the light-transmitting substrate ranges from 1.5 to 6.

For example, according to an embodiment of the present disclosure, a ratio of a radius of curvature of the second lens to the second dimension ranges from 0.4 to 0.6, and a ratio of the second dimension to a largest dimension of the second lens in a direction perpendicular to the light-transmitting substrate ranges from 2 to 7.

For example, according to an embodiment of the present disclosure, a refractive index of the first lens is greater than a refractive index of the light-transmitting substrate.

For example, according to an embodiment of the present disclosure, a refractive index of the second lens is greater than a refractive index of the light-transmitting substrate.

For example, according to an embodiment of the present disclosure, an angle of light emitted from the backlight source is in a range of +a degrees, and a is not greater than 5.

Another embodiment of the present disclosure provides a display device, including a display panel and the backlight source as mentioned above, the display panel is disposed on a light-exit side of the backlight source.

For example, according to an embodiment of the present disclosure, the display panel includes a plurality of sub-pixels, a maximum size of each sub-pixel in the direction parallel to the light-transmitting substrate is a fourth dimension, and a distance between adjacent first lenses is less than the fourth dimension.

### BRIEF DESCRIPTION OF DRAWINGS

In order to clearly illustrate the technical solution of the embodiments of the present disclosure, the drawings of the embodiments will be briefly described in the following; it is obvious that the described drawings are only related to some examples of the present disclosure and thus are not limitative of the present disclosure.

FIG. 1 is an optical pathway diagram of a display device applying VR technology.

FIG. 2 is a partial structure diagram of a collimated backlight source.

FIG. 3 is a partial sectional structural diagram of a backlight source provided by the present disclosure.

FIG. 4A is a partial planar structure schematic diagram of a light source in a backlight source provided by an example of the present disclosure.

FIGS. 4B and 4C are planar structure schematic diagrams of one light-emitting unit in different examples.

FIG. 5 is an optical pathway diagram of one first lens, one second lens and a light-transmitting substrate in the backlight source shown in FIG. 3.

FIG. 6 is an optical pathway diagram of one first lens, one second lens and a light-transmitting substrate in the backlight source in another example.

FIG. 7 is an optical pathway diagram in the case where only a first lens is provided in the backlight source.

FIG. 8 is an optical pathway diagram of an optical structure formed by one first lens, a light-transmitting substrate and multiple second lenses in the backlight source shown in FIG. 3.

FIG. 9 is a convergence angle relationship diagram corresponding to the structure shown in FIG. 7 and the structure shown in FIG. 8 for matching different sizes of light-emitting units at different sizes.

FIG. 10 is a curve chart of influence of an air gap between a second lens and a light source on a convergence angle and uniformity of a backlight source.

FIG. 11 is a curve chart of influence of an air gap between a second lens and a light source on luminous efficacy of a backlight source.

FIG. 12 is a curve chart of influence of thickness change of a light-transmitting substrate on a collimation angle and brightness uniformity of a backlight source in the case where second lenses have different second sizes.

FIG. 13 is a curve chart of influence of thickness change of a light-transmitting substrate on luminous efficacy in the case where second lenses have different second sizes.

FIG. 14 is a curve chart of influence of thickness change of a light-transmitting substrate on a collimation angle and brightness uniformity of a backlight source in the case where second lenses have different second sizes.

FIG. 15 is a curve chart of influence of thickness change of a light-transmitting substrate on luminous efficacy in the case where second lenses have different second sizes.

FIG. 16 is a brightness distribution diagram in the case where only the first lens is provided in the backlight source shown in FIG. 7.

FIG. 17A is an orthographic projection relationship diagram of some first lenses, some second lenses, and some light-emitting units of the backlight source shown in FIG. 3 in an example.

FIG. 17B is an orthographic projection relationship diagram of some first lenses, some second lenses, and some light-emitting units of the backlight source shown in FIG. 3 in another example.

FIG. 17C is an orthographic projection relationship diagram of some first lenses, some second lenses, and some light-emitting units of the backlight source shown in FIG. 3 in still another example.

FIG. 18 is a brightness distribution diagram of the backlight source shown in FIG. 17A.

FIG. 19 is an orthographic projection relationship diagram of some first lenses, some second lenses, and some light-emitting units of the backlight source shown in FIG. 3 in still another example.

FIG. 20 is a brightness distribution diagram of the backlight source shown in FIG. 19.

FIG. 21 is a relationship diagram of the convergence angle and brightness of the backlight source shown in FIG. 3.

FIG. 22 is a partial structure diagram of a display device provided by another embodiment of the present disclosure.

### DETAILED DESCRIPTION

In order to make objects, technical details and advantages of the embodiments of the present disclosure apparent, the technical solutions of the embodiment will be described in a clearly and fully understandable way in connection with the drawings related to the embodiments of the present disclosure. It is obvious that the described embodiments are just a part but not all of the embodiments of the present disclosure. Based on the described embodiments herein, those skilled in the art can obtain other embodiment(s), without any inventive work, which should be within the scope of the present disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. The terms “comprise,” “comprising,” “include,” “including,” etc., are intended to specify that the elements or the objects stated before these terms encompass the elements or the objects and equivalents thereof listed after these terms, but do not preclude the other elements or objects. The features “parallel”, “perpendicular” and “same” used in the embodiments of the present disclosure all include features such as “parallel”, “perpendicular” and “same” in the strict sense, and the cases having certain errors, such as “approximately parallel”, “approximately perpendicular”, “substantially the same” or the like, taking into account measurements and errors associated with the measurement of a particular quantity (e.g., limitations of the measurement system), and indicate being within an acceptable range of deviation for a particular value as determined by one of ordinary skill in the art. For example, “approximately” may indicate being within one or more standard deviations, or within 10% or 5% of the stated value. In the case that the quantity of a component is not specifically indicated below in the embodiments of the present disclosure, it means that the component may be one or more, or may be understood as at least one. “At least one” means one or more, and “plurality” means at least two.

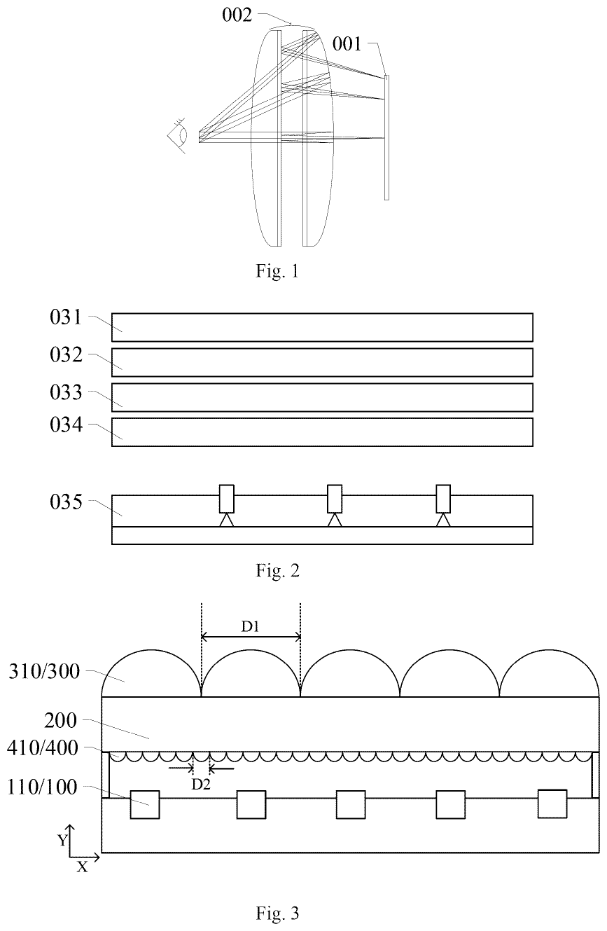

FIG. 1 is an optical pathway diagram of a display device applying VR technology. As illustrated in FIG. 1, the display device includes a display panel, a backlight source 001, and a lens group 002 located at light-exit sides of the display panel and the backlight source 001. For example, the lens group 002 can adopt a folding optical path (Pancake).

In the research, the inventors of the present application found that the pixel transmittance of the display panel shown in FIG. 1 is only 2%, and the light efficiency is about 20% for the lens group 002 with Pancake optical path, and the human eye needs at least 100 nits, so the backlight brightness needs to be 100÷0.2÷0.02=25000 nit. Thus, the required backlight brightness is 2 to 5 times that of ordinary backlight brightness which leads to higher power consumption of a backlight source.

In a display device adopting pixel-level dimming technology, such as the addition of a dimming lens at the bottom of a pixel, the light originally incident in the non-light-transmitting region and being blocked is deflected into the light-transmitting region through a dimming lens, for example, an opening of a black matrix, so as to increase the light transmission, and the problem of high backlight power consumption can be solved.

However, by setting the maximum thickness of the above-mentioned dimming lens as 3.5 microns, where the dimming lens is a plano-convex lens and has the refractive index of 1.8 as an example, simulating the variation of gain with changes in the radius of curvature of the dimming lens reveals: when the light-exit angle of the backlight source is 20 degrees, the gain does not exceed 120%; when the light-exit angle of the backlight source is 10 degrees, the gain can reach up to 150%. Thus, only in the case where the backlight source has high collimation, such as the light-exit angle is within ±5 degrees, the overall light efficiency of the display device using pixel-level dimming technology can be improved greatly.

FIG. 2 is a partial structure diagram of a collimated backlight source. As illustrated in FIG. 2, the collimated light source includes a light source plate 035, and a diffusion structure 034, a light conversion structure 033, a light gathering structure 032 and a collimating structure 031 on the light-exit side of the light source plate 035. For example, the light source plate 035 includes a plurality of light sources, a reflective layer, and a driving circuit board. For example, a light mixing distance OD is set between the light source and the diffusion structure 034. For example, the light conversion structure 033 includes a quantum dot conversion layer, such as converting blue light into red light or green light. For example, the diffusion structure 034 may include a diffusion plate. For example, the collimating structure 031 may include a prism layer, a brightness enhancement film etc. As illustrated in FIG. 2, the thickness from the collimating structure 031 to the diffusion structure 034 is about 0.97 millimeters, the light mixing distance from the light-emitting side of the light source plate 035 is about 0.5 millimeters, and the thickness of the light source plate 035 is about 0.22 millimeters. Thus, the thickness of the collimated backlight source is about 1.7 millimeters.

An embodiment of the present disclosure provides a backlight source and a display device. The backlight source includes a light source, a light-transmitting substrate, a first lens group and a second lens group. The light source includes a plurality of light-emitting units; the light-transmitting substrate is located at a light-emitting side of the light source; the first lens group is located at a light-exit side of the light-transmitting substrate, and the first lens group includes a plurality of first lenses; the second lens group is located at a light incident side of the light-transmitting substrate, and the second lens group includes a plurality of second lenses. The largest dimension of each first lens in a direction parallel to the light-transmitting substrate is a first dimension, the largest dimension of each second lens in the direction parallel to the light-transmitting substrate is a second dimension, and the first dimension is greater than the second dimension, and an orthographic projection of at least one second lens on the light-transmitting substrate overlaps with an outline of an orthographic projection of at least one first lens on the light-transmitting substrate or is located in an interval between orthographic projections of adjacent first lenses on the light-transmitting substrate. The largest dimension of each light-emitting unit in the direction parallel to the light-transmitting substrate is a third dimension, a ratio of the second dimension to the third dimension ranges from 0.2 to 0.5, and a ratio of the second dimension to the first dimension ranges from 0.04 to 0.2.

In the backlight source provided by the present disclosure, by setting the first lens and the second lens on both sides of the light-transmitting substrate respectively, and setting the relative positional relationship between the first lens and the second lens, and the relationships among the first dimension of the first lens, the second dimension of the second lens and the third dimension of the light-emitting unit, the backlight source can have high collimation and high uniformity.

The backlight and the display device provided by the embodiment of the present disclosure are described below with reference to the drawings.

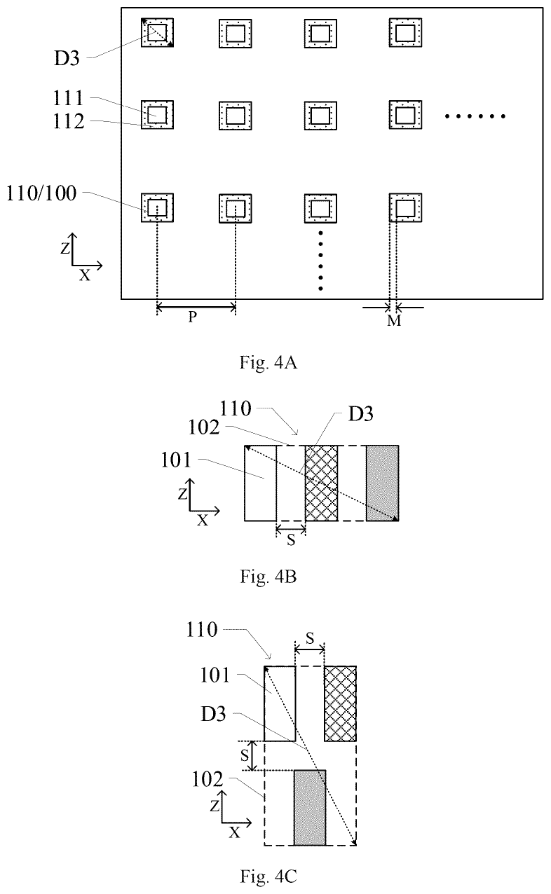

FIG. 3 is a partial sectional structural diagram of a backlight source provided by the present disclosure. FIG. 4A is a partial planar structure schematic diagram of a light source in a backlight source provided by an example of the present disclosure.

As illustrated in FIGS. 3 and 4A, the backlight source includes a light source 100, a light-transmitting substrate 200, a first lens group 300 and a second lens group 400. The light source 100 includes a plurality of light-emitting units 110. For example, the plurality of light-emitting units 100 may be arranged in an array along the X direction and the Z direction.

As illustrated in FIG. 3, the light-transmitting substrate 200 is located at a light-emitting side of the light source 100. For example, the light-transmitting substrate 200 may be a solid substrate or a hollow substrate. For example, an air gap is provided between the light-transmitting substrate 200 and the light source 100.

As illustrated in FIG. 3, the first lens group 300 is located at a light-exit side of the light-transmitting substrate 200, for example, the first lens group 300 is located at a side of the light-transmitting substrate 200 away from the light source 100. The first lens group 300 includes a plurality of first lenses 310. The second lens group 400 is located at a light incident side of the light-transmitting substrate 200, for example, the second lens group 400 is located between the light-transmitting substrate 200 and the light source 100. The second lens group 400 includes a plurality of second lenses 410.

As illustrated in FIG. 3, the largest dimension of each first lens 310 in a direction parallel to the light-transmitting substrate 200 is a first dimension D1, and the largest dimension of each second lens 410 in the direction parallel to the light-transmitting substrate 200 is a second dimension D2, and the first dimension D1 is greater than the second dimension D2. The light-transmitting substrate 200 includes a main plane perpendicular to the Y direction, and the direction parallel to the light-transmitting substrate 200 may be a direction parallel to the main plane. For example, the number of the second lenses 410 is greater than the number of the first lenses 310. The first dimension D1 of the first lens 310 as mentioned above may be an aperture of the first lens 310 and the second dimension D2 of the second lens 410 as mentioned above may be an aperture of the second lens 410. For example, a shape of an orthographic projection of the first lens 310 as mentioned above on the light-transmitting substrate 200 may be circular, and the first dimension D1 is a diameter of the circle. A shape of an orthographic projection of the second lens 410 as mentioned above on the light-transmitting substrate 200 may also be circular, and the second dimension D2 may be a diameter of the circle. For example, the shape of the orthographic projection of the first lens 310 as mentioned above on the light-transmitting substrate 200 may also be other shapes, such as quadrangles, pentagons, hexagons, octagons and other polygons, and the first dimension D1 may be a length of the longest diagonal in the polygons. For example, the shape of the orthographic projection of the second lens 320 as mentioned above on the light-transmitting substrate 200 may also be other shapes, such as quadrangles, pentagons, hexagons, octagons and other polygons, and the second dimension may be a length of the longest diagonal in the polygons. The present disclosure takes the largest dimension of each first lens in the direction parallel to the light-transmitting substrate, that is, each first dimension is strictly equal as an example.

Considering the process error, there may be a certain difference in the first dimensions of different first lenses, such as the certain difference is not more than 10% of the first dimension. The present disclosure takes the largest dimension of each second lens in the direction parallel to the light-transmitting substrate, that is, each second dimension is strictly equal as an example. Considering the process error, there may be a certain difference in the second dimensions of different second lenses, such as the certain difference is not more than 10% of the second dimension.

As illustrated in FIG. 3, an orthographic projection of at least one second lens 410 on the light-transmitting substrate 200 overlaps with an outline of an orthographic projection of at least one first lens 310 on the light-transmitting substrate 200 or is located in an interval between orthographic projections of adjacent first lenses 310 on the light-transmitting substrate 200. For example, the outline of an orthographic projection of each first lens 310 on the light-transmitting substrate 200 overlaps with the orthographic projection of the second lenses 410 on the light-transmitting substrate 200. For example, an orthographic projection of a center of the at least one first lens 310 on the light-transmitting substrate 200 is located within the orthographic projection of the second lens 410 on the light-transmitting substrate 200. For example, the orthographic projection of the at least one first lens 310 on the light-transmitting substrate 200 overlaps with orthographic projections of at least two second lenses 410 on the light-transmitting substrate 200.

As illustrated in FIGS. 3 and 4A, the largest dimension of each light-emitting unit 110 in the direction parallel to the light-transmitting substrate 200 is a third dimension D3, a ratio of the second dimension D2 to the third dimension D3 ranges from 0.2 to 0.5, and a ratio of the second dimension D2 to the first dimension D1 ranges from 0.04 to 0.2. For example, the third dimension D3 as mentioned above may be the largest dimension of a light-emitting region of the light-emitting unit 110 in the direction parallel to the light-transmitting substrate, for example, a shape of the light-emitting region may be polygonal, and the third dimension D3 may be a length of a diagonal of the light-emitting region. The present disclosure takes the largest dimension of each light-emitting unit in the direction parallel to the light-transmitting substrate, that is, the third dimension is strictly equal as an example. Considering the process error, there may be a certain difference in the third dimensions of different light-emitting units, such as the certain difference is not more than 10% of the third dimension.

In some examples, as illustrated in FIG. 3, an angle of light emitted from the backlight source is in a range of ta degrees, and a is not greater than 5. For example, α can be 5, or 4.9, or 4.8, or 4.7, or 4.6, or 4.5, etc. For example, the light uniformity of the backlight source is not less than 83.3%. For example, the light uniformity of the backlight source is not less than 85%.

In the backlight source provided by the present disclosure, by arranging the first lens and the second lens on both sides of the light-transmitting substrate respectively, arranging the second lens to overlap the outline edge of the first lens or the gap between adjacent first lenses, and at the same time setting the relationships among the first dimension of the first lens, the second dimension of the second lens and the third dimension of the light-emitting unit, the backlight source can have high collimation within ±5 degrees and high uniformity not less than 83.3%.

Compared with the backlight source shown in FIG. 2, the backlight source provided by the present disclosure adopts the first lens group as a collimating structure, and realizes the functions of diffusion and convergence by the second lens group, and reduces a light mixing distance by the cooperation of the first lens group and the second lens group, so as to be beneficial to reducing the thickness of the backlight source. For example, the thickness of the backlight source is reduced to 1.5 micrometers or even below 1.1 micrometers, the thickness reduction can reach 40%.

Applying the backlight source with high collimation provided by the present disclosure to the display device as illustrated in FIG. 1, matching the display panel with pixel-level dimming function, is beneficial to improving the brightness of the display device, such as increasing the brightness gain ratio by 1.5, reducing the power consumption of the display device, such as reducing the power consumption by 30%, and improving the overall equipment life.

For example, as illustrated in FIG. 3, the ratio of the second dimension D2 to the third dimension D3 ranges from ⅕ to ⅓, and the ratio of the second dimension D2 to the first dimension D1 ranges from 1/15 to 1/9. For example, the ratio of the second dimension D2 to the third dimension D3 ranges from 0.24 to 0.4, and the ratio of the second dimension D2 to the first dimension D1 ranges from 0.05 to 0.15.

For example, as illustrated in FIG. 3, each first lens 310 has the same shape and size, and each second lens 410 has the same shape and size. For example, each first lens 310 has the same refractive index, and each second lens 410 has the same refractive index.

For example, as illustrated in FIG. 3, the second lens 410 may be formed on the surface of the light-transmitting substrate 200. However, it is not limited thereto. In other examples, after the second lens is formed on other substrates, the second lens may be attached to the surface of the light-transmitting substrate.

In some examples, as illustrated in FIG. 3, a distance between the optical axis of the at least one first lens 310 and the optical axis of a second lens 410 closest to the optical axis of the at least one first lens 310 is less than 15 microns. For example, the optical axis of the first lens 310 and the optical axis of the second lens 410 are both perpendicular to the light-transmitting substrate 200, such as extending in the Y direction.

For example, as illustrated in FIG. 3, the distance between the optical axis of the at least one first lens 310 and the optical axis of the second lens 410 is less than 10 microns. For example, the distance between the optical axis of the at least one first lens 310 and the optical axis of the second lens 410 is less than 5 microns. For example, the optical axis of the at least one first lens 310 coincides with the optical axis of the second lens 410. For example, the optical axis of each first lens 310 coincides with the optical axis of the corresponding second lens 410, which is beneficial to ensure that the vertex of the emission spectrum corresponds to the 0° position.

In some examples, as illustrated in FIGS. 3 and 4A, a ratio of the first dimension D1 to a pitch P of the adjacent light-emitting units 110 ranges from 0.7 to 1.3. The pitch P of the adjacent light-emitting units 110 may refer to a length of a line connecting centers of the adjacent light-emitting units 110. For example, the ratio of the first dimension D1 to the pitch P of adjacent light-emitting units 110 ranges from 0.9 to 1.2. For example, the ratio of the first dimension D1 to the pitch P of adjacent light-emitting units 110 ranges from 0.8 to 1.1. For example, the ratio of the first dimension D1 to the pitch P of adjacent light-emitting units 110 ranges from 0.95 to 1.05. For example, the first dimension D1 is equal to the pitch of the adjacent light-emitting units 110, so as to improve the light efficiency and ensure the brightness uniformity of the light-emitting surface.

For example, as illustrated in FIG. 3, the adjacent light-emitting units 110 may refer to the adjacent light-emitting units 110 arranged in the X direction or the adjacent light-emitting units 110 arranged in the direction perpendicular to the XY plane.

In some examples, as illustrated in FIG. 3, the plurality of first lenses 310 are arranged in one-to-one correspondence with the plurality of light-emitting units 110. For example, the number of the plurality of first lenses 310 is the same as the number of the plurality of light-emitting units 110.

In some examples, as illustrated in FIG. 3, the first lens 310 includes a plano-convex lens and the second lens 410 includes a plano-convex lens, and the plane of the first lens 310 and the plane of the second lens 410 both face the light-transmitting substrate 200.

In some examples, as illustrated in FIGS. 3 and 4A, each light-emitting unit 110 is configured to emit white light. For example, each light-emitting unit 110 includes a light-emitting diode 111 of one color and a color conversion layer 112, and the color conversion layer 112 wraps the light-emitting diode 111 so that non-white light emitted by the light-emitting diode 111 is converted into white light through the color conversion layer 112. For example, the light-emitting diode 111 of one color may be a blue light-emitting diode. For example, the color conversion layer 112 may include a quantum dot material or a color conversion material such as phosphor. For example, the shape of the light-emitting unit 110 may be rectangular, and the third dimension D3 may be a diagonal dimension of the light-emitting region formed by the light exited from the color conversion layer 112. For example, a distance M between an edge of the color conversion layer 112 and an edge of the light-emitting diode 111 may be 15 microns. Of course, the shape of the light-emitting area is not limited to rectangle, for example, it can also be circular, elliptical, triangular, rhombic, pentagonal, hexagonal, octagonal and other regular shapes, or it can also be other irregular shapes, such as rounded polygons, shapes with curved edges and so on. The third dimension as mentioned above can be the diameter of a circle, the long axis of an ellipse, the longest diagonal of other polygons and so on.

FIGS. 4B and 4C are planar structure schematic diagrams of one light-emitting unit in different examples.

For example, as illustrated in FIGS. 4B and 4C, the at least one light-emitting unit 110 includes sub-light-emitting units 101 of different colors. Each light-emitting unit 110 includes light emit diodes 101 of different colors to emit white light. For example, each light-emitting unit 110 may include a red light-emitting diode, a green light-emitting diode, and a blue light-emitting diode. For example, the red light-emitting diode, the green light-emitting diode and the blue light-emitting diode may be tiled as illustrated in FIG. 4B or tiled as illustrated in FIG. 4C. For example, the third dimension D3 of the light-emitting unit 110 may be the largest dimension of the light-emitting region 102 formed by the red light-emitting diode, the green light-emitting diode and the blue light-emitting diode, for example, the shape of the light-emitting region 102 may be rectangular, and the third dimension D3 is the length of the diagonal of the rectangle. Of course, the present disclosure is not limited thereto, and sub light-emitting units with different colors can also be arranged perpendicular to the XZ plane shown in FIG. 4B. In this case, the shapes of the light-emitting regions of the sub light-emitting units with different colors may be the same, and the orthogonal projections thereof on the XZ plane coincide, and the third dimension is the largest dimension of one of the light-emitting regions, such as the diagonal dimension and the circular diameter.

For example, a value of the distance S between adjacent light-emitting diodes 101 in the same light-emitting unit 110 shown in FIGS. 4B and 4C is greater than a value of the distance M shown in FIG. 4A, for example, S may be 75 microns. Thus, the light-emitting units with different structures may have different sizes, and the sizes of the light-emitting units emitting white light are influence factors on the sizes of the first lens and the second lens.

For example, as illustrated in FIG. 3 to FIG. 4C, for light-emitting units with the same light efficiency, the larger the size of the light-emitting unit, the larger the corresponding pitch, which satisfies the same backlight brightness. The backlight brightness Lbl of the backlight source satisfies a relationship: Lbl=N*Le*Ae/(P*P), where N is the required number of light-emitting units, Le is the brightness of light-emitting units, Ae is the light-emitting area of light-emitting units, and P is the pitch between adjacent light-emitting units. It can be seen that the greater P is, the smaller N is required, and the corresponding power consumption is lower for light-emitting units with the same light efficiency.

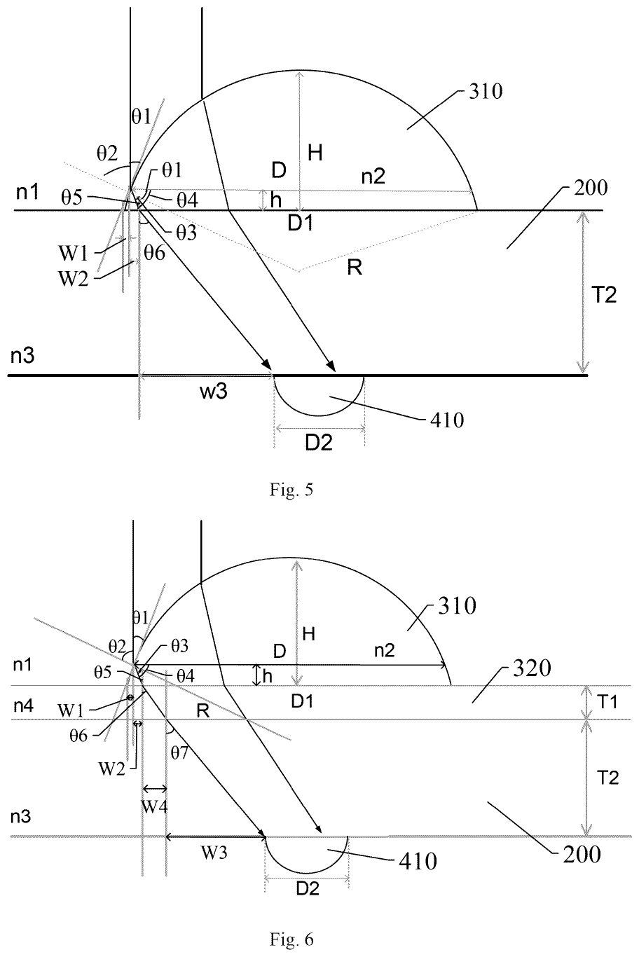

FIG. 5 is an optical pathway diagram of one first lens, one second lens and the light-transmitting substrate in the backlight source shown in FIG. 3.

In some examples, as illustrated in FIGS. 3 and 5, the first lens 310 and the second lens 410 each include a plano-convex lens including a spherical surface.

For example, as illustrated in FIG. 5, the first lens 310 may be in direct contact with the light-transmitting substrate 200.

For example, as illustrated in FIG. 5, it can be determined that the aperture D1 of the first lens 310 is the pitch of the adjacent light-emitting units by the power consumption, backlight brightness and photoelectric characteristics of the light-emitting units, and then the collimated light rays are traced backward from the center to the aperture edge of the first lens 310, so that each light ray enters the aperture D2 of the second lens 410. The aperture D2 of the second lens 410 is determined by the refractive index n2, the radius of curvature R, the aperture D1 and the arch height H of the first lens 310, the thickness T2 and the refractive index n3 of the light-transmitting substrate 200, and the refractive index n1 of the media other than the first lens 310 and the light-transmitting substrate 200.

For example, as illustrated in FIG. 5, an angle between a light ray incident on the edge of the first lens 310 and a tangent of a curved surface of the first lens 310 is θ1 and the light ray is perpendicular to the surface of the light-transmitting substrate 200, and the angle between the light ray and the normal of the curved surface of the first lens 310 is θ2, and when the light ray enters the first lens 310, it is refracted at an angle of refraction θ3. An angle between the light ray incident in the first lens 310 and the normal of the surface of the light-transmitting substrate 200 is θ5, and when the light ray enters the light-transmitting substrate 200, it is refracted at an angle of refraction θ6. A distance between a position where the light ray enters the first lens 310 and a surface of the light-transmitting substrate 200 close to the first lens 310 is h, and a distance twice the amount between this position and the highest point of the first lens 310 in the direction parallel to the light-transmitting substrate 200 is D. According to the geometric relationship and Snell's law, the following relationship can be obtained:

$$θ 1 = arc cos [ ( D / 2 ) / R ] \qquad ( 1 )$$

$$θ 2 = π / 2 - θ 1 \qquad ( 2 )$$

$$θ 3 = arc sin [ ( n 1 * sin θ 2 ) / n 2 ] \qquad ( 3 )$$

$$θ 4 = θ 1 + θ 3 \qquad ( 4 )$$

$$θ 5 = π / 2 - θ 4 \qquad ( 5 )$$

$$θ 6 = arc sin [ ( n 2 * sin θ 5 ) / n 3 ] \qquad ( 6 )$$

$$W 1 = ( D 1 - D ) / 2 \qquad ( 7 )$$

$$h = H - \{ R - {[ {R}^{2} - {( D / 2 )}^{2} ]}^{2} \} \qquad ( 8 )$$

$$W 2 = h * tan θ 5 \qquad ( 9 )$$

$$W 3 = T 2 * tan θ 6 \qquad ( 10 )$$

$$D 2 = D 1 - 2 * ( W 1 + W 2 + W 3 ) \qquad ( 11 )$$

By substituting the relevant parameters in the above-mentioned relationships (1)~(10) into the relationship (11), one value of D2 can be obtained, and a plurality of values of D2 can be obtained for the collimated ray tracing incident on different positions of the first lens 310, where the largest value of D2 is the aperture value that can be adopted by the second lens 410. The aperture value is the aperture D2 of the second lens 410 in the case where the refractive index n2, the radius of curvature R, the aperture D1, the arch height H of the first lens 310, the thickness T2 and the refractive index n3 of the light-transmitting substrate 200 and the refractive index n1 of media other than the first lens 310 and the light-transmitting substrate 200 are parameters in one set.

For example, as illustrated in FIG. 5, the first lens 310 and the light-transmitting substrate 200 can select two materials, the refractive indices n2 and n3 are determined values, and assuming that the medium other than the first lens 310 and the light-transmitting substrate 200 is air, the refractive index n1 is also a determined value. In this case, the minimum value of D2 can be obtained by adjusting the thickness T2 of the light-transmitting substrate 200, the curvature radius R and the arch height H of the first lens 310. The value of D2 can be used as the minimum value for the aperture D2 of the second lens 410. For example, in the case of adjusting the values of the thickness T2 of the light-transmitting substrate 200, the radius of curvature R and the arch height H of the first lens 310, it is also required to consider the influence of the aperture of the second lens on the collimation and brightness uniformity of the backlight source, as well as the processing technology of the second lens, so the aperture of the second lens may be equal to or greater than the above minimum value.

FIG. 6 is an optical pathway diagram of one first lens, one second lens and the light-transmitting substrate in the backlight source in another example.

For example, as illustrated in FIG. 6, a spacer layer 320 is disposed between the first lens 310 and the light-transmitting substrate 200. The difference between the backlight source shown in FIG. 6 and the backlight source shown in FIG. 5 is that the spacer layer 320 is disposed between the first lens 310 and the light-transmitting substrate 200. For example, the first lens 310 can be formed on the spacer layer 320 and the spacer layer 320 is attached to the surface of the light-transmitting substrate 200.

For example, as illustrated in FIG. 6, it can be determined that the aperture D1 of the first lens 310 is the pitch of the adjacent light-emitting units by the power consumption, backlight brightness and photoelectric characteristics of the light-emitting units, and then the collimated light rays are traced backward from the center to the aperture edge of the first lens 310, so that each light ray enters the aperture D2 of the second lens 410. The aperture D2 of the second lens 410 is determined by the refractive index n2, the radius of curvature R, the aperture D1 and the arch height H of the first lens 310, the thickness T1 and the refractive index n4 of the spacer layer 320, the thickness T2 and the refractive index n3 of the light-transmitting substrate 200, and the refractive index n1 of the media other than the first lens 310 and the light-transmitting substrate 200.

For example, As illustrated in FIG. 6, an angle between a light ray incident on the edge of the first lens 310 and a tangent of a curved surface of the first lens 310 is θ1 and the light ray is perpendicular to a surface of the spacer layer 320, and an angle between the light ray and the normal of the curved surface of the first lens 310 is θ2, and when the light ray enters the first lens 310, it is refracted at an angle of refraction θ3. An angle between the light ray incident on the first lens 310 and the normal of the surface of the spacer layer 320 is θ5, and when the light ray enters the spacer layer 320, it is refracted at an angle of refraction θ6. An angle between the light ray incident on the light-transmitting substrate 200 and the normal of the surface of the light-transmitting substrate 200 is θ6, and when the light ray enters the light-transmitting substrate 200, it is refracted at an angle of refraction θ7. The arch height of the first lens 310 is H, the distance between the position where the light ray enters the first lens 310 and the surface of the spacer layer 320 close to the first lens 310 is h, and a distance twice the amount between this position and the highest point of the first lens 310 in the direction parallel to the light-transmitting substrate 200 is D. According to the geometric relationship and Snell's law, the following relationship can be obtained:

$$θ 1 = arc cos [ ( D / 2 ) / R ] \qquad ( {1}^{′} )$$

$$θ 2 = π / 2 - θ 1 \qquad ( {2}^{′} )$$

$$θ 3 = arc sin [ ( n 1 * sin θ 2 ) / n 2 ] \qquad ( {3}^{′} )$$

$$θ 4 = θ 1 + θ 3 \qquad ( {4}^{′} )$$

$$θ 5 = π / 2 - θ 4 \qquad ( {5}^{′} )$$

$$θ 6 = arc sin [ ( n 2 * sin θ 5 ) / n 4 ] \qquad ( {6}^{′} )$$

$$θ 7 = arc sin [ ( n 4 * sin θ 6 ) / n 3 ] \qquad ( {7}^{′} )$$

$$W 1 = ( D 1 - D ) / 2 \qquad ( {8}^{′} )$$

$$h = H - \{ R - {[ {R}^{2} - {( D / 2 )}^{2} ]}^{2} \} \qquad ( {9}^{′} )$$

$$W 2 = h * tan θ 5 \qquad ( {10}^{′} )$$

$$W 4 = T 1 * tan θ 6 \qquad ( {11}^{′} )$$

$$W 3 = T 2 * tan θ 7 \qquad ( {12}^{′} )$$

$$D 2 = D 1 - 2 * ( W 1 + W 2 + W 3 + W 4 ) \qquad ( {13}^{′} )$$

By substituting the relevant parameters in the above-mentioned relationships (1′)~(12′) into the relationship (13′), one value of D2 can be obtained, and a plurality of values of D2 can be obtained for the collimated ray tracing incident on different positions of the first lens 310, where the largest value of D2 is the aperture value that can be adopted by the second lens 410. The aperture value is the aperture D2 of the second lens 410 in the case where the refractive index n2, the radius of curvature R, the aperture D1, the arch height H of the first lens 310, the thickness T2 and the refractive index n3 of the light-transmitting substrate 200, the thickness T1 and refractive index n4 of the spacer layer 320, and the refractive index n1 of the medium other than the first lens 310 and the light-transmitting substrate 200 are parameters in one set.

For example, as illustrated in FIG. 5, the first lens 310, the spacer layer 320 and the light-transmitting substrate 200 can select three materials, the refractive indices n2, n4 and n3 are determined values, and assuming that the medium other than the first lens 310 and the spacer layer 320 is air, the refractive index n1 is also a determined value. In this case, the minimum value of D2 can be obtained by adjusting the thickness T1 of the spacer layer 320, the thickness T2 of the light-transmitting substrate 200, the curvature radius R and the arch height H of the first lens 310. The value of D2 can be used as the minimum value for the aperture D2 of the second lens 410. For example, in the case of adjusting the values of the thickness T1 of the spacer layer 320, the thickness T2 of the light-transmitting substrate 200, the radius of curvature R and the arch height H of the first lens 310, it is also required to consider the influence of the aperture of the second lens on the collimation and brightness uniformity of the backlight source, as well as the processing technology of the second lens, so the aperture of the second lens may be equal to or greater than the above minimum value.

Thus, in the above-mentioned embodiments shown in FIGS. 5 and 6, under the comprehensive consideration of various factors, by adjusting various parameters, the ratio of the second dimension of the second lens to the third dimension of the light-emitting unit ranges from 0.2 to 0.5, and the ratio of the second dimension of the second lens to the first dimension of the first lens ranges from 0.04 to 0.2.

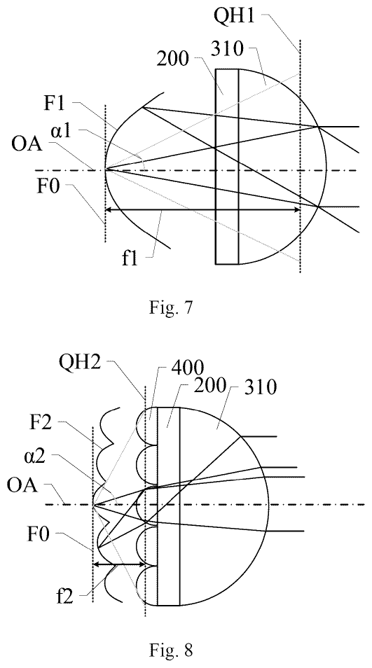

FIG. 7 is an optical pathway diagram in the case where only the first lens is provided in the backlight source. FIG. 8 is an optical pathway diagram of an optical structure formed by one first lens, one light-transmitting substrate and multiple second lenses in the backlight source shown in FIG. 3.

For example, as illustrated in FIG. 7, in the case where one side of the light-transmitting substrate 200 is provided with the first lens 310, and the other side of the light-transmitting substrate 200 is not provided with the second lens 410, the focal surface F1 has a large deviation from the ideal focal plane F0 because of the existence of field curvature. In addition, in the present structure, the aperture angle α1 is small, and the distance between the ideal focal plane F0 and the object principal plane QH1, such as the focal length f1, is large. In order to reduce the focal length of the backlight shown in FIG. 7, it may be considered to arrange another lens on the other side of the light-transmitting substrate where the first lens is not arranged, and the number of the lenses may be the same as that of the first lens, and the aperture of the lens may be equivalent to that of the first lens.

For example, as illustrated in FIG. 8, relative to the backlight source shown in FIG. 7, by arranging the second lens 410 on the other side of the light-transmitting substrate 200, an offset distance between the focal surface F2 and the ideal focal plane F0 can be reduced, so that the optical structure composed of the second lens 410, the light-transmitting substrate 200 and the first lens 310 can correct the field curvature, causing various positions on the curved focal surface F2 to closely approach the ideal focal plane F0, thereby enabling collimated emission for larger-sized light-emitting units. Moreover, the curved focal surface F2 has a plurality of peaks close to the ideal focal plane F0 and has a deflection of light effect. For example, in addition to allowing light sources located on the optical axis to emit collimated light, this configuration also enables off-axis light sources near the other peaks of the curved focal surface F2, which are closer to the ideal focal plane F0, to emit collimated light. While enhancing the collimation of light-exiting from the first lens, it also achieves scattering functionality, homogenizing energy distribution, thus improving and ensuring uniformity.

For example, as illustrated in FIG. 8, compared with the arrangement of lenses with the same number and the same aperture on the other side of the light-transmitting substrate where the first lenses are not arranged, the backlight source provided by the present disclosure can disperse the light while achieving short focus, and improve the uniformity of light emission of the backlight, and can realize that the light emitted by the light-emitting unit with an angle of more than ±80° can enter the corresponding first lens.

For example, As illustrated in FIG. 8, compared with the backlight shown in FIG. 7, by providing the second lens 410, the focal distance f2 between the ideal focal plane F0 and the object main surface QH2 is reduced, that is, the focal power of the optical structure composed of the second lens 410, the light-transmitting substrate 200 and the first lens 310 is increased, for example, the focal power of the first lens 310 is 1/f01, and the focal power of the second lens 410 is 1/f02. The focal power of the optical structure satisfies 1/f=1/f01+1/f02, so as to achieve the short-focus effect, for example, the object main surface QH2 of the optical structure is pulled towards the light source, thereby increasing the aperture angle α2 and enhancing the converging ability of the optical structure and reducing the mixing distance between the light source and the second lens while improving the light efficiency, thereby reducing the thickness of the backlight.

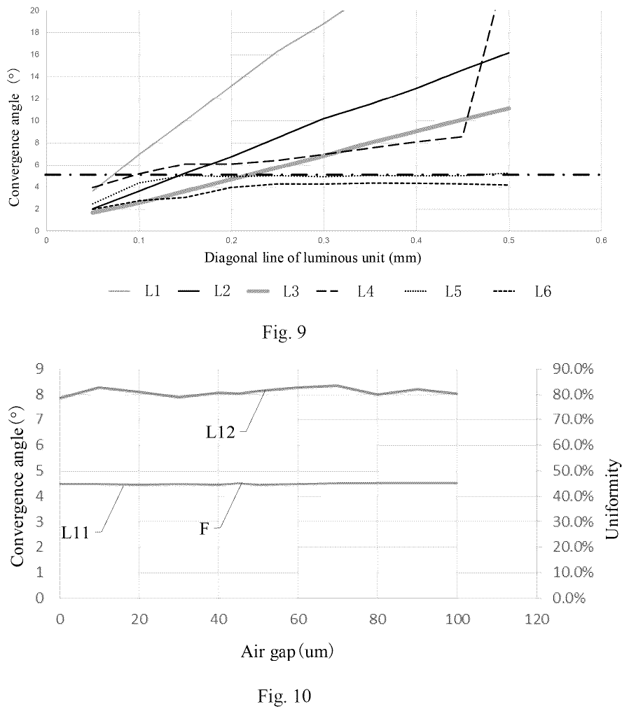

FIG. 9 is a convergence angle relationship diagram corresponding to the structure shown in FIG. 7 and the structure shown in FIG. 8 for matching different sizes of light-emitting units at different sizes.

For example, as illustrated in FIG. 9, line L1, line L2 and line L3 all represent the curves of the structure in which only the first lens is provided in the backlight source; line L4, line L5 and line L6 represent the curves of the structure in which the first lens and the second lens shown in FIG. 3 are provided in the backlight source. Both L1 line and L4 line correspond to the first lens with a radius of curvature of 0.3 mm; both L2 line and L5 line correspond to the first lens with a radius of curvature of 0.6 mm; both L3 line and L6 line correspond to the first lens with a radius of curvature of 0.9 mm. Each curve corresponds to one first lens.

For example, as illustrated in FIG. 9, in the case where a single first lens has the same aperture, for example, the radius of curvature of the first lens is 0.6 millimeters, it can be seen that the diagonal size of the light-emitting unit in the backlight with only the first lens should not exceed 145 microns, while the diagonal size of the light-emitting unit in the backlight with the first lens and the second lens should not exceed 330 microns when the convergence angle of L2 and L5 lines is less than 5. For example, when selecting a light-emitting unit, the light-emitting units shown in FIGS. 4B to 4C or the light-emitting unit shown in FIG. 4A can be selected. In selecting the light-emitting units shown in FIGS. 4B to 4C, because the pitch S is about 75 microns, the actual light-emitting width of the light-emitting unit is less than 70 microns in the backlight source with only the first lens, and the actual light-emitting width of the light-emitting unit can reach more than 200 microns in the backlight source with the first lens and the second lens. Thus, the backlight source with the first lens and the second lens shown in FIG. 3 can realize high collimation, and at the same time, a light-emitting unit with a larger size can be used to reduce power consumption. The convergence angle can also be called collimation angle.

In some examples, as illustrated in FIGS. 3 and 5, the radius of curvature R of the first lens 310 is equal to 0.4~0.6 of the first dimension D1, and the ratio of the first dimension D1 to the largest dimension H of the first lens 310 in the direction perpendicular to the light-transmitting substrate 200 ranges from 1.5 to 6. For example, the ratio of the first dimension D1 to the maximum dimension H of the first lens 310 in the direction perpendicular to the light-transmitting substrate 200 ranges from 1.6 to 4. For example, the ratio of the first dimension D1 to the maximum dimension H of the first lens 310 in the direction perpendicular to the light-transmitting substrate 200 ranges from 1.7 to 3. For example, the ratio of the first dimension D1 to the maximum dimension H of the first lens 310 in the direction perpendicular to the light-transmitting substrate 200 ranges from 1.8 to 5. For example, the ratio of the first dimension D1 to the maximum dimension H of the first lens 310 in the direction perpendicular to the light-transmitting substrate 200 ranges from 1.9 to 2.1. For example, the first dimension D1 (aperture D1) is twice the radius of curvature R of the first lens 310. For example, the first dimension D1 is twice the thickness H of the first lens 310.

For example, as illustrated in FIGS. 3 and 5, in order to improve the light energy utilization rate of the light-emitting unit 110 at a large angle, it is necessary to reduce the focal length f of the optical structure including the first lens 310, the light-transmitting substrate 200 and the second lens 410 and the focal length f is determined by the relation 1/f=1/f10+1/f20. For example, in the process of determining the aperture D2 of the second lens 410 in the examples shown in FIGS. 5 and 6, the curvature radius R of the first lens 310 can be optimized as much as possible. For example, on the one hand, considering the process factors, the radius of curvature R and the aperture D1 of the first lens 310 need to satisfy the following relations: R≥D1/2; on the other hand, according to the focal length formula of plano-convex lens, f=R/Δn, where An represents the refractive index difference between the first lens 310 and other media (such as air), and the focal length of the first lens 310 is directly proportional to the radius of curvature R. In order to reduce the focal length f of the optical structure, the focal length of the first lens 310 should be as small as possible, and the radius of curvature R of the first lens 310 should also be smaller. Thus, considering the process factors and short focal length factors comprehensively, the radius of curvature of the first lens is as close as possible to half the aperture.

For example, as illustrated in FIG. 5, the maximum dimension H (such as the arch height or the central thickness), the radius of curvature R and the aperture D1 of the first lens 310 satisfy the relationship: R²=(R−H)²+(D1/2)². According to the numerical relationship between the radius of curvature R and the aperture D1, it can be obtained that the thickness H of the first lens is approximately half of the aperture D1. D1/H is an index of the processing ability of the first lens in technology.

In some examples, as illustrated in FIGS. 3 and 5, the radius of curvature of the second lens 410 is equal to 0.4~0.6 of the second dimension D2, and the ratio of the second dimension D2 to the largest dimension of the second lens 410 in the direction perpendicular to the light-transmitting substrate 200 ranges from 2 to 7. For example, the ratio of the second dimension D2 to the largest dimension of the second lens 410 in the direction perpendicular to the light-transmitting substrate 200 is 2.1~4. For example, the ratio of the second dimension D2 to the largest dimension of the second lens 410 in the direction perpendicular to the light-transmitting substrate 200 is 2.5~3. For example, the ratio of the second dimension D2 to the largest dimension of the second lens 410 in the direction perpendicular to the light-transmitting substrate 200 is 2.8~5. For example, the ratio of the second dimension D2 to the largest dimension of the second lens 410 in the direction perpendicular to the light-transmitting substrate 200 is 4.5~6. For example, the second dimension D2 of the second lens 410 is twice the radius of curvature. For example, the second dimension D2 is twice the thickness of the second lens 410 and is beneficial to reduce the focal length of the second lens. Similarly, referring to the first lens, the setting of the numerical relationship of the radius of curvature, aperture and thickness of the second lens provided by the present disclosure needs to comprehensively consider the process factor and the short focus factor.

In some examples, as illustrated in FIGS. 3 and 8, an orthographic projection of each first lens 310 on the light-transmitting substrate 200 overlaps with orthographic projections of at least two second lenses 410 on the light-transmitting substrate 200, and an optical structure is formed by the first lens 310, the light-transmitting substrate 200 and the at least two second lenses 410, with their orthographic projections overlapping, and a distance between at least one light-emitting unit 110 and a focal plane of its corresponding optical structure is not more than 50 microns. For example, the distance between each light-emitting unit 110 and the focal plane of its corresponding optical structure is not more than 50 microns. For example, the distance between at least one light-emitting unit 110 and the focal plane of its corresponding optical structure is not more than 45 microns. For example, the distance between at least one light-emitting unit 110 and the focal plane of its corresponding optical structure is not more than 40 microns. For example, the distance between at least one light-emitting unit 110 and the focal plane of its corresponding optical structure is not more than 35 microns. For example, the distance between at least one light-emitting unit 110 and the focal plane of its corresponding optical structure is not more than 30 microns. For example, the distance between at least one light-emitting unit 110 and the focal plane of its corresponding optical structure is not more than 25 microns. For example, the distance between at least one light-emitting unit 110 and the focal plane of its corresponding optical structure is not more than 20 microns. For example, the distance between at least one light-emitting unit 110 and the focal plane of its corresponding optical structure is not more than 15 microns. For example, the distance between at least one light-emitting unit 110 and the focal plane of its corresponding optical structure is not more than 10 microns. For example, the distance between at least one light-emitting unit 110 and the focal plane of its corresponding optical structure is not more than 5 microns. For example, the light-emitting unit may be located on the focal plane of its corresponding optical structure.

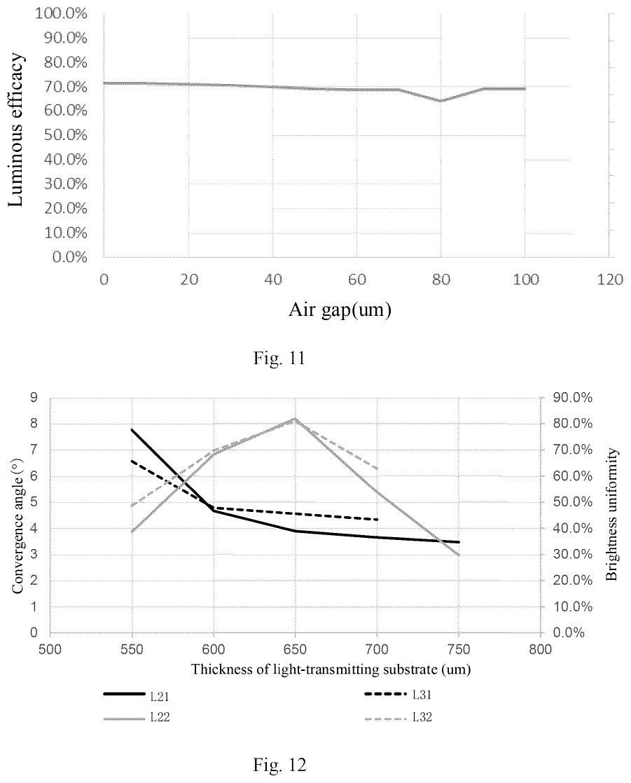

FIG. 10 is a curve chart of influence of an air gap between a second lens and a light source on a convergence angle and uniformity of a backlight source. FIG. 11 is a curve chart of influence of an air gap between a second lens and a light source on luminous efficacy of a backlight source.

For example, as illustrated in FIGS. 10 and 11, the line L11 represents the relationship curve between the air gap and the convergence angle of the backlight source, line L12 represents the relationship curve between the air gap and the uniformity of the backlight source, and position F is the focus of the optical structure including the first lens, the light-transmitting substrate and the second lens.

For example, as illustrated in FIGS. 10 and 11, taking the refractive index of the first lens as 1.7, the refractive index of the light-transmitting substrate as 1.5, the refractive index of the second lens as 1.6, the maximum size of the light-emitting unit as 268 microns, and the ratio of the aperture to the center thickness of the first lens as 2 as an example, the influence of the air gap shown in FIGS. 10 and 11 on the convergence angle, uniformity and luminous efficacy of the backlight is obtained. For example, the air gap may be no greater than 45 microns.

For example, as illustrated in FIGS. 10 and 11, in the case where the air gap fluctuates within the range of 50 microns near the focal plane, the convergence angle of the backlight source is basically unchanged, for example, at about 5 degrees, the surface uniformity of the light emitted from the backlight source changes in a wave-like manner; the luminous efficacy of the backlight source is basically maintained at about 70%.

In some examples, as illustrated in FIG. 3, the ratio of the thickness of the light-transmitting substrate 200 to the largest dimension of the second lens 410 in the direction perpendicular to the light-transmitting substrate 200 ranges from 8 to 20. For example, the maximum dimension of the second lens 410 in the direction perpendicular to the light-transmitting substrate 200 may be the center thickness or arch height of the second lens 410. For example, the ratio of the thickness of the transparent substrate 200 to the largest dimension of the second lens 410 in the direction perpendicular to the transparent substrate 200 is 10~15. For example, the ratio of the thickness of the transparent substrate 200 to the largest dimension of the second lens 410 in the direction perpendicular to the transparent substrate 200 is 9~12. For example, the ratio of the thickness of the transparent substrate 200 to the largest dimension of the second lens 410 in the direction perpendicular to the transparent substrate 200 is 11~16. For example, the ratio of the thickness of the transparent substrate 200 to the largest dimension of the second lens 410 in the direction perpendicular to the transparent substrate 200 is 14~18.

In some examples, as illustrated in FIG. 3, the refractive index of the first lens 310 is greater than the refractive index of the light-transmitting substrate 200. For example, the larger the refractive index of the first lens set, the thinner the thickness of the light-transmitting substrate can be set, which is beneficial to realize the thin-and-light design of the backlight source.

In some examples, as illustrated in FIG. 3, the refractive index of the second lens 410 is greater than the refractive index of the light-transmitting substrate 200. For example, the refractive index of the first lens 310 is greater than the refractive index of the second lens 410.

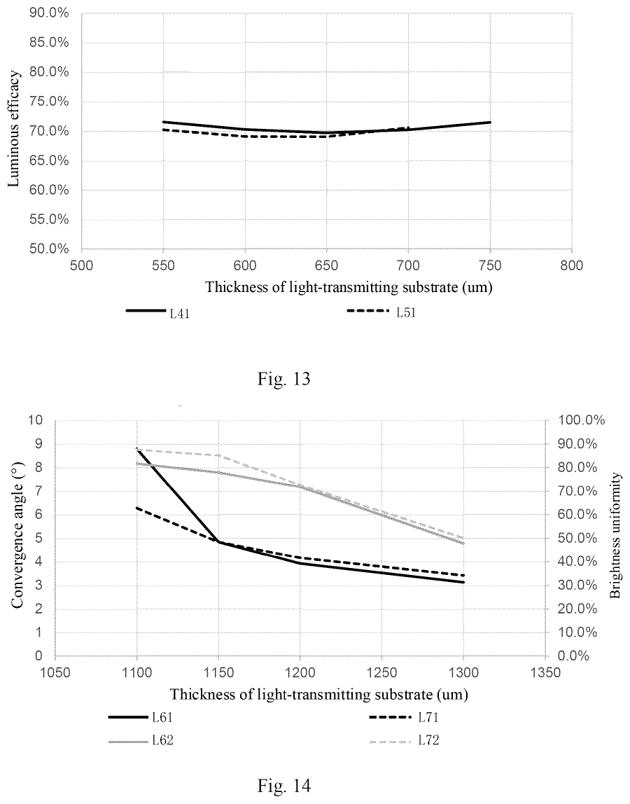

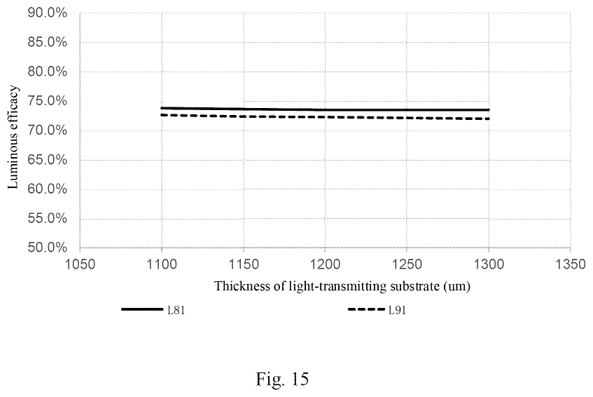

FIG. 12 is a curve chart of influence of thickness change of a light-transmitting substrate on a collimation angle and brightness uniformity of a backlight source in the case where second lenses have different second sizes. FIG. 13 is a curve chart of influence of thickness change of a light-transmitting substrate on luminous efficacy in the case where second lenses have different second sizes. FIG. 14 is a curve chart of influence of thickness change of a light-transmitting substrate on a collimation angle and brightness uniformity of a backlight source in the case where second lenses have different second sizes. FIG. 15 is a curve chart of influence of thickness change of a light-transmitting substrate on luminous efficacy in the case where second lenses have different second sizes. The curve charts shown in FIGS. 12 and 13 have the same third dimension of the light-emitting unit, and the curve charts shown in FIGS. 14 and 15 have the same third dimension of the light-emitting unit, and FIGS. 15 and 13 respectively correspond to different third dimensions of the light-emitting unit.

For example, as illustrated in FIGS. 12 and 13, taking the light-emitting unit being the structure shown in FIG. 4A, and the diagonal length of the light-emitting unit being 268 micrometers, the refractive index of the first lens being 1.7, the refractive index of the light-transmitting substrate being 1.5, the refractive index of the second lens being 1.6, the radius of curvature of the first lens being 693 micrometers, the aperture to the arch height ratio of the first lens being 2, the aperture of the first lens being 1.13~1.21 millimeters, and the pitch of the light-emitting unit being 1.13~1.21 millimeters, as an example, the range of values of D2 can be calculated by referring to the above relations (1)~(11), or relations (1′)~(13′). L21 represents the collimation curve in the case where the aperture of the second lens is 85 microns, L22 represents the brightness uniformity curve in the case where the aperture of the second lens is 85 microns, L31 represents a collimation curve in the case where the aperture of the second lens is 100 micrometers, L32 represents a brightness uniformity curve in the case where the aperture of the second lens is 100 micrometers, L41 represents a luminous efficacy curve in the case where the aperture of the second lens is 85 micrometers, and L51 represents a luminous efficacy curve in the case where the aperture of the second lens is 100 micrometers. For example, considering aperture of the second lens can be 85 and 100 microns, the convergence angle of the backlight source is less than 5 and the luminous efficacy is about 70% in the case where the thickness of the transparent substrate is greater than 600 microns, but the brightness uniformity of the backlight source gradually decreases in the case where the thickness of the transparent substrate is greater than 650 microns. Thus, in the case where the aperture of the second lens is 85 microns or 100 microns and the thickness of the transparent substrate is 650 microns, the collimation angle can be less than 5, the luminous efficacy is about 70%, and the brightness uniformity is more than 80%.

For example, as illustrated in FIGS. 14 and 15, taking the light-emitting unit being the structure shown in FIG. 4B or 4C, and the diagonal length of the light-emitting unit being 500 micrometers, the refractive index of the first lens being 1.7, the refractive index of the light-transmitting substrate being 1.5, the refractive index of the second lens being 1.6, the radius of curvature of the first lens being 1270 micrometers, the aperture to arch height ratio of the first lens being 2, the aperture of the first lens being 1.8~3 millimeters, and the pitch of the light-emitting unit being 2.16~3 millimeters, as an example, the range of values of D2 can be calculated by referring to the above relations (1)~(11), or relations (1′)~(13′). L61 represents the collimation curve in the case where the aperture of the second lens is 120 microns, L62 represents the brightness uniformity curve in the case where the aperture of the second lens is 120 microns, L71 represents a collimation curve in the case where the aperture of the second lens is 140 micrometers, L72 represents a brightness uniformity curve in the case where the aperture of the second lens is 140 micrometers, L81 represents a luminous efficacy curve in the case where the aperture of the second lens is 120 micrometers, and L91 represents a luminous efficacy curve in the case where the aperture of the second lens is 140 micrometers. For example, considering the aperture of the second lens can be 120 and 140 microns, the convergence angle of the backlight source is less than 5 and the luminous efficacy is about 70%~75% in the case where the thickness of the transparent substrate is greater than 1150 microns, but the brightness uniformity of the backlight source gradually decreases in the case where the thickness of the transparent substrate is greater than 1150 microns. Thus, in the case where the aperture of the second lens is 140 microns and the thickness of the transparent substrate is 1150 microns, the collimation angle can be less than 5, the luminous efficacy is about 70%~75%, and the brightness uniformity is more than 80%.

For example, as illustrated in FIG. 3, in the case where the diagonal length of the light-emitting unit 110 is 268 micrometers, the maximum thickness of the second lens 410 is 0.05 millimeters, the thickness of the light transmissive substrate 200 is 0.65 millimeters, the thickness of the first lens 310 is 0.46~0.63 millimeters, and the overall thickness of the backlight source is 1.68~1.82 millimeters.

For example, as illustrated in FIG. 3, in the case where the diagonal length of the light-emitting unit 110 is 120 micrometers, the maximum thickness of the second lens 410 is 0.02 micrometers, the thickness of the light transmitting substrate 200 is 0.2 millimeters, the thickness of the first lens 310 is 0.15~0.2 millimeters, and the overall thickness of the backlight source is 0.95~1.05 millimeters.

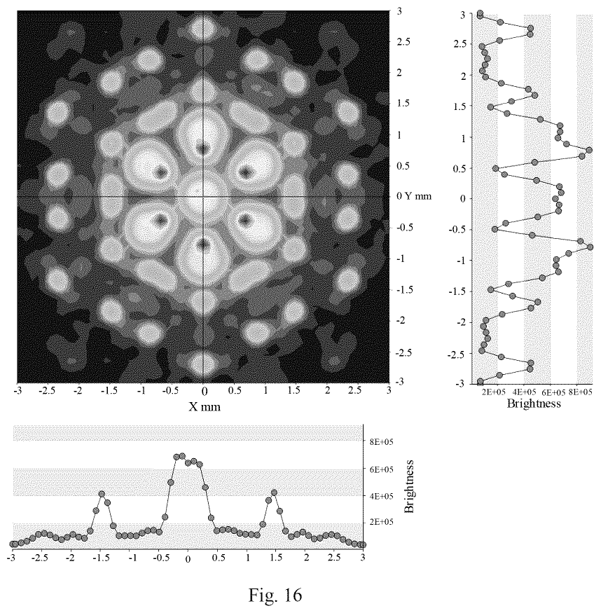

FIG. 16 is a brightness distribution diagram in the case where only the first lens is provided in the backlight source shown in FIG. 7. The diagram in the upper left corner of FIG. 16 illustrates the brightness distribution on a light-exit surface of the backlight source, and the diagram in the lower left corner illustrates the brightness curve diagram where Y equals 0; the diagram on the right side illustrates the brightness curve diagram where X equals 0. The two curve diagrams illustrate the luminance fluctuations across the light-exit surface.

For example, as illustrated in FIGS. 16 and 7, in the case where there is a gap between adjacent first lenses, light-exiting the gap between the first lenses is not refracted by the first lenses, and the gap reduces the surface uniformity of the backlight source. For example, in the case where the projection of the first lens is circular, even if adjacent circles are closely aligned, the circular tangency would still leave a gap, and the gap would result in a decrease in the surface uniformity of the backlighting.

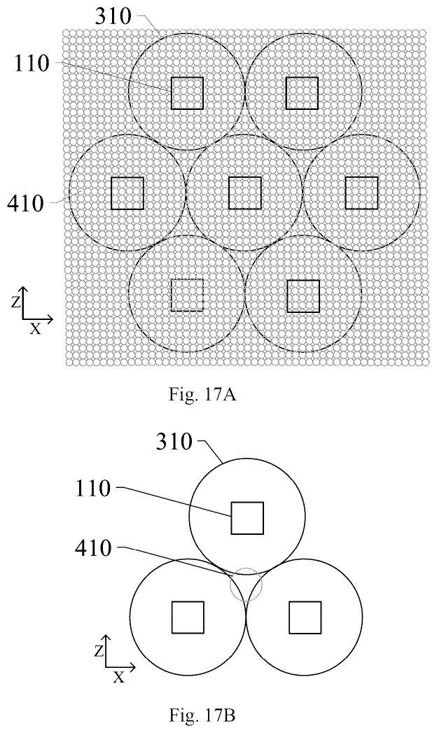

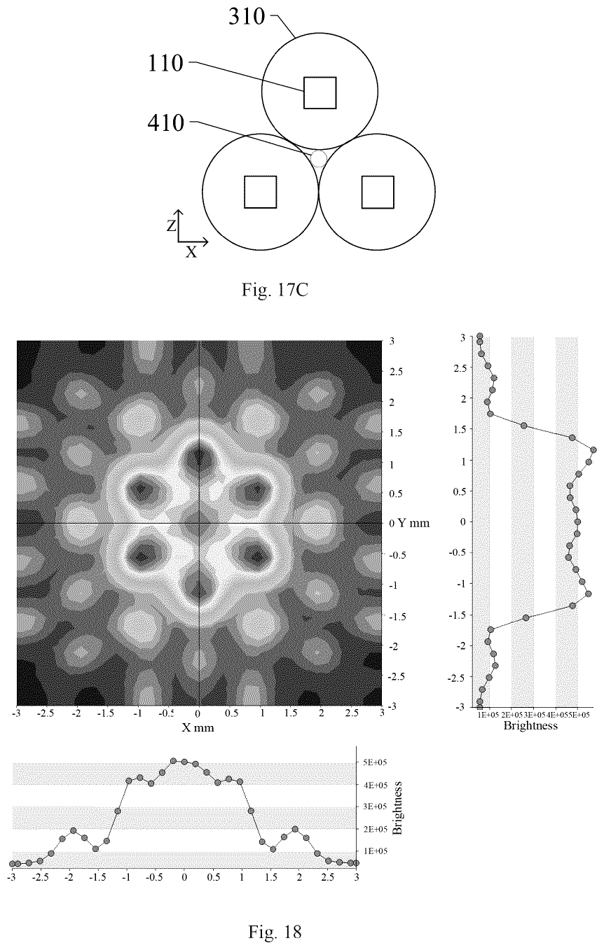

FIG. 17A is an orthographic projection relationship diagram of some first lenses, some second lenses, and some light-emitting units of the backlight source shown in FIG. 3 in an example. FIG. 18 is a brightness distribution diagram of the backlight source shown in FIG. 17A.

In some examples, as illustrated in FIG. 17A, the plurality of first lenses 310 are closely arranged and the plurality of second lenses 410 are closely arranged, to facilitate improving the surface uniformity of the backlight source.

In some examples, as illustrated in FIG. 17A, a shape of an orthographic projection of each first lens 310 on the light-transmitting substrate includes a circle, a gap between orthographic projections of any adjacent first lenses 310 on the light-transmitting substrate overlaps with the orthographic projection of the at least one second lens 410 on the light-transmitting substrate. For example, gaps between orthographic projections of adjacent first lenses 310 on the light-transmitting substrate overlap with orthographic projections of some second lenses 410 on the light-transmitting substrate. For example, the orthographic projection of at least one second lens 410 on the light-transmitting substrate is completely located within the gap. For example, the some second lenses 410 include three kinds of second lenses 410, which have different positional relationships with the first lens 310, for example, a first type of second lens 410 has an orthographic projection that is completely located within the orthographic projection of the first lens 310, a second type of second lens 410 has an orthographic projection that overlaps with an orthographic projection of an edge of the first lens 310, and a third type of second lens 410 has an orthographic projection that does not overlap at all with the orthographic projection of the first lens 310. For example, adjacent first lenses 310 may refer to three first lenses 310 whose orthographic projections are edge-to-edge.

By using the second lens to fill the gap between adjacent first lenses, the light passing through the gap between adjacent first lenses will be deflected by the second lens, such as in the collimation direction, which is beneficial to improving the surface uniformity of the light emitted from the backlight source.

For example, as illustrated in FIG. 18, relative to the diagram shown in FIG. 16, the luminance fluctuations of the brightness curves of the backlight source at X=0 and Y=0 are smaller, and the surface uniformity of the backlight source is improved.

In some examples, as illustrated in FIG. 17A, the geometric center of the gap falls within the orthographic projection of the second lens 410 on the light-transmitting substrate, which facilitates further improvement of the surface uniformity of the backlight source. For example, the geometric center of the gap falls within the orthographic projection of one second lens 410 on the light-transmitting substrate, and the one second lens 410 is located entirely within the gap. For example, the optical axis of the second lens 410 passes through the geometric center of the gap overlapping the second lens 410.

FIG. 17B is an orthographic projection relationship diagram of some first lenses, some second lenses, and some light-emitting units of the backlight source shown in FIG. 3 in another example. In the example shown in FIG. 17B and the example shown in FIG. 17A, the first lenses have the same aperture and the second lenses have different apertures, the aperture of the second lens shown in FIG. 17B is greater than the aperture of the second lens shown in FIG. 17A.

In some examples, as illustrated in FIG. 17B, the shape of the orthographic projection of each first lens 310 on the light-transmitting substrate includes a circle, a gap between the orthographic projections of any adjacent first lenses 310 on the light-transmitting substrate overlaps with the orthographic projections of at least one second lens 410 on the light-transmitting substrate, the geometrical center of the gap falls within the an orthographic projection of one second lens 410 on the light-transmitting substrate, and the orthographic projection of the one second lens 410 on the light-transmitting substrate overlaps with the orthographic projection of the first lens 310 on the light-transmitting substrate. FIG. 17B only illustrates one second lens with an orthographic projection overlapped with a gap, and omits other second lenses.

For example, as illustrated in FIG. 17B, three adjacent first lenses 310 are tangent to each other, and the orthographic projection of the one second lens 410 described above may be overlapped with the orthographic projection of at least one of the three first lenses 310. For example, the orthographic projection of the one second lens 410 described above may be overlapped with the orthographic projections of the three first lenses 310, but not limited thereto, the orthographic projection of the one second lens described above may also be overlapped with the orthographic projections of one first lens or two first lenses.

FIG. 17C is an orthographic projection relationship diagram of some first lenses, some second lenses, and some light-emitting units of the backlight source shown in FIG. 3 in still another example. In the example shown in FIG. 17C and the example shown in FIGS. 17A and 17B, the first lenses have the same aperture and the second lenses have different apertures, the aperture of the second lens shown in FIG. 17C is greater than the aperture of the second lens shown in FIG. 17A and smaller than the aperture of the second lens shown in FIG. 17B.

In some examples, as illustrated in FIG. 17C, the shape of the orthographic projection of each first lens 310 on the light-transmitting substrate includes a circle, an gap between the orthographic projections of any adjacent first lenses 310 on the light-transmitting substrate overlaps with the orthographic projections of at least one second lens 410 on the light-transmitting substrate, the geometrical center of the above-mentioned gap falls within the orthographic projections of one second lens 410 on the light-transmitting substrate, and the orthographic projection of the above-mentioned one second lens 410 on the light-transmitting substrate is tangent to the orthographic projection of the first lens 310 on the light-transmitting substrate. FIG. 17C only illustrates one second lens with an orthographic projection tangent to the orthographic projection of the first lens, and omits other second lenses.

For example, as illustrated in FIG. 17C, three adjacent first lenses 310 are tangent to each other, and the orthographic projection of the above-mentioned one second lens 410 may be tangent to the orthographic projection of at least one of the three first lenses 310. For example, the orthographic projection of the one second lens 410 mentioned above may be tangent to the orthographic projections of three first lenses 310, but without limitation, the orthographic projection of the one second lens mentioned above may also be tangent to the orthographic projections of one first lens or two first lenses.

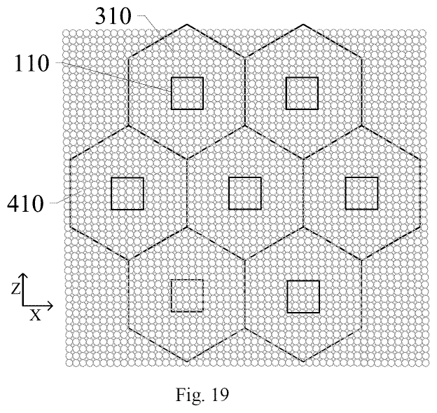

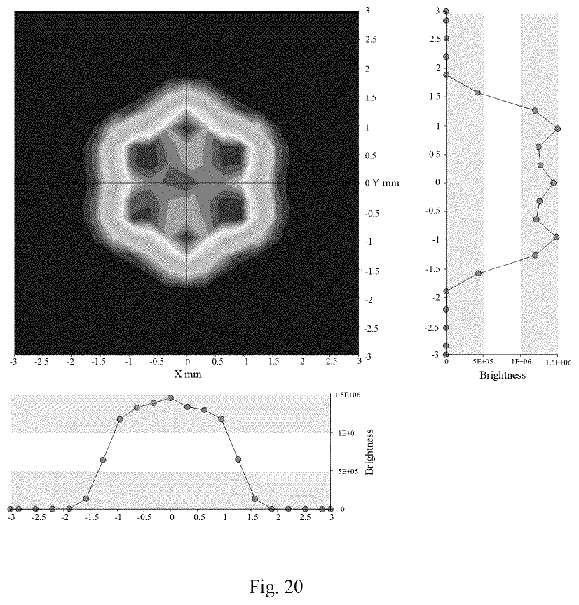

FIG. 19 is an orthographic projection relationship diagram of some first lenses, some second lenses, and some light-emitting units of the backlight source shown in FIG. 3 in still another example. FIG. 20 is a brightness distribution diagram of the backlight source shown in FIG. 19.

In some examples, as illustrated in FIG. 19, the shape of the orthographic projection of each first lens 310 on the light-transmitting substrate includes a hexagonal shape, there is essentially no gap between the orthographic projections of adjacent first lenses 310 on the light-transmitting substrate, and the orthographic projection of the at least one second lens 410 on the light-transmitting substrate is overlapped with outlines of the orthographic projections of at least two first lenses 310 on the light-transmitting substrate. For example, adjacent edges of adjacent first lenses 310 with hexagonal orthographic projections contacting to achieve a close arrangement to match the second lenses with smaller apertures can alleviate the concentration effect of the first lens on the light to achieve a short focal length and at the same time improve the light exit efficiency as well as the light uniformity of the same first lens, thereby improving the uniformity of the surface light source of the backlight source.

For example, as illustrated in FIG. 20, relative to the diagram shown in FIG. 18, the luminance fluctuation of the brightness curve of the backlight source at X=0 and Y=0 is smaller, and the surface uniformity of the backlight source can be further improved by further reducing the gap between the first lenses.

For example, as illustrated in FIGS. 17A and 19, the shape of the orthographic projection of the second lens 410 on the light-transmitting substrate may be a circle, but is not limited thereto, and may be a polygon such as a hexagon, an octagon, and the like.

For example, as illustrated in FIGS. 17A and 19, the plurality of second lenses 410 may be arrayed along the X-direction and the Z-direction. But it is not limited thereto, for example, two adjacent rows of second lenses arranged along the Z direction may be offset with respect to each other in distribution, facilitating further reduction of the gap between adjacent second lenses.

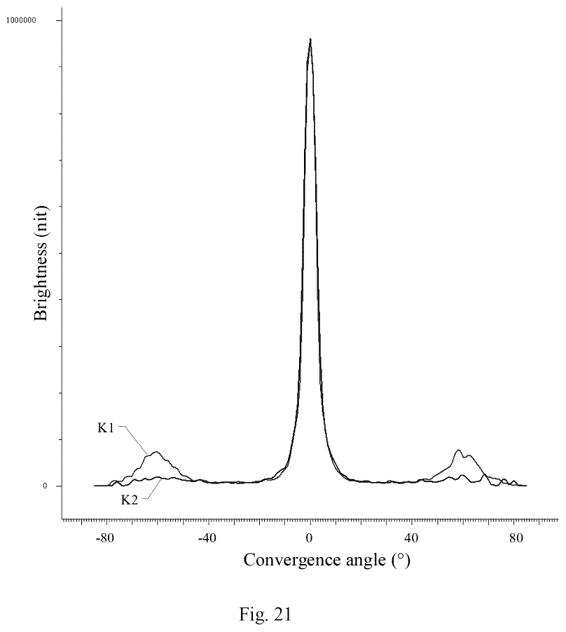

FIG. 21 is a relationship diagram of the convergence angle and brightness of the backlight source shown in FIG. 3. For example, as illustrated in FIGS. 21, K1 and K2 respectively represent the relationship between the luminance and the convergence angle of light emitted by the backlight source in two different directions, the two different directions may be the X-direction and the Z-direction as illustrated in FIG. 4A, and the spectral diagrams of the two different directions are basically coincident. For example, the backlight source emits light in two different directions at ±5 degrees with a brightness of about 150,000 nits, and the maximum brightness of the backlight source is close to 1,000,000 nits. For example, the backlight sources all have one peak. For example, by setting the light source of the backlight source near the focal plane of the optical structure, the backlight source can be avoided from emitting the multi-peak spectrum, favoring the effect of an ultra-high collimation surface light source.

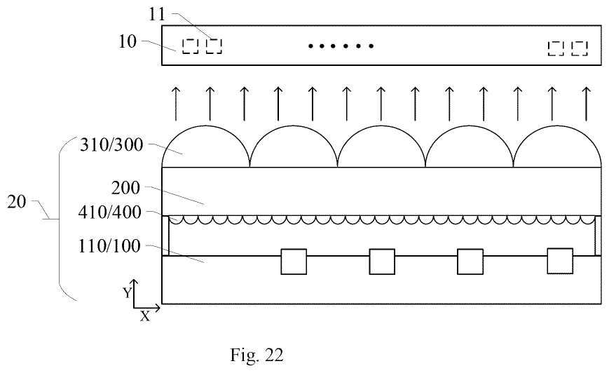

FIG. 22 is a partial structure diagram of a display device provided by another example of the present disclosure. As illustrated in FIG. 22, the display device includes the backlight source 20 in any of the above embodiments and a display panel 10 disposed on the light-exit side of the backlight source 20.

In some examples, as illustrated in FIG. 22, the display panel 10 includes a plurality of sub-pixels 11, the maximum size of each sub-pixel parallel to the light-transmitting substrate 200 is a fourth dimension, and a distance between adjacent first lenses 310 is less than the fourth dimension. By setting the distance between adjacent first lenses to be smaller than the dimensions of the sub-pixels, it is favorable to reduce the influence of the gap between the first lenses in the backlight source on the light uniformity as well as the influence on the display screen of the display panel.

For example, as illustrated in FIG. 22, the display panel 10 may be a liquid crystal display panel including an array substrate and an opposing substrate disposed opposite each other, and a liquid crystal layer disposed between the array substrate and the opposing substrate. For example, the sub-pixel 11 may include a pixel electrode and a common electrode. The maximum size of the above-mentioned sub-pixel in a direction parallel to the light-transmitting substrate may be the maximum size of the light-exit region of the sub-pixel, for example, the light-exit region may be a region defined by a black matrix disposed on the opposed substrate, and the light-exit region is parallel to the light-exit surface of the backlight source.

The following statements should be noted:
(1) In the accompanying drawings of the embodiments of the present disclosure, the drawings involve only the structure(s) in connection with the embodiment(s) of the present disclosure, and other structure(s) can be referred to common design(s).
(2) In case of no conflict, features in one embodiment or in different embodiments can be combined.

What have been described above are only specific implementations of the present disclosure, the protection scope of the present disclosure is not limited thereto, and the protection scope of the present disclosure should be based on the protection scope of the claims.

1. A backlight source, comprising:
a light source, comprising a plurality of light-emitting units;
a light-transmitting substrate, located at a light-emitting side of the light source;
a first lens group, located at a light-exit side of the light-transmitting substrate, and the first lens group comprising a plurality of first lenses;
a second lens group, located at a light incident side of the light-transmitting substrate, and the second lens group comprising a plurality of second lenses;
wherein a largest dimension of each first lens in a direction parallel to the light-transmitting substrate is a first dimension, a largest dimension of each second lens in the direction parallel to the light-transmitting substrate is a second dimension, and the first dimension is greater than the second dimension, and an orthographic projection of at least one second lens on the light-transmitting substrate overlaps with an outline of an orthographic projection of at least one first lens on the light-transmitting substrate or is located in an interval between orthographic projections of adjacent first lenses on the light-transmitting substrate;
a largest dimension of each light-emitting unit in the direction parallel to the light-transmitting substrate is a third dimension, a ratio of the second dimension to the third dimension ranges from 0.2 to 0.5, and a ratio of the second dimension to the first dimension ranges from 0.04 to 0.2.

2. The backlight source according to claim 1, wherein a ratio of the first dimension to a pitch of adjacent light-emitting units ranges from 0.7 to 1.3.

3. The backlight source according to claim 1, wherein a distance between an optical axis of at least one first lens and an optical axis of a second lens closest to the optical axis of the at least one first lens is less than 15 microns.

4. The backlight source according to claim 1, wherein the plurality of first lenses are arranged in one-to-one correspondence with the plurality of light-emitting units, an orthographic projection of each first lens on the light-transmitting substrate overlaps with orthographic projections of at least two second lenses on the light-transmitting substrate, and an optical structure is formed by the first lens, the light-transmitting substrate and the at least two second lenses, with their orthographic projections overlapping, and a distance between at least one light-emitting unit and a focal plane of its corresponding optical structure is not more than 50 microns.

5. The backlight source according to claim 1, wherein the plurality of first lenses are closely arranged and the plurality of second lenses are closely arranged.

6. The backlight source according to claim 5, wherein a shape of an orthographic projection of each first lens on the light-transmitting substrate comprises a hexagonal shape, there is essentially no gap between the orthographic projections of the adjacent first lenses on the light-transmitting substrate, and the orthographic projection of the at least one second lens on the light-transmitting substrate overlaps with outlines of orthographic projections of at least two first lenses on the light-transmitting substrate.

7. The backlight source according to claim 5, wherein a shape of an orthographic projection of each first lens on the light-transmitting substrate comprises a circle, a gap between orthographic projections of any adjacent first lenses on the light-transmitting substrate overlaps with the orthographic projection of the at least one second lens on the light-transmitting substrate.

8. The backlight source according to claim 5, wherein a shape of an orthographic projection of each first lens on the light-transmitting substrate comprises a circle, a gap is between orthogonal projections of any adjacent first lenses on the transparent substrate, the orthographic projection of the at least one second lens on the light-transmitting substrate is completely located within the gap.

9. The backlight source according to claim 7, wherein a geometric center of the gap falls within an orthographic projection of one second lens on the light-transmitting substrate, and the orthographic projection of the one second lens on the light-transmitting substrate is completely located within the gap.

10. The backlight source according to claim 7, wherein a geometric center of the gap falls within an orthographic projection of one second lens on the light-transmitting substrate, and the orthographic projection of the one second on the light-transmitting substrate overlaps or tangents with an orthographic projection of the first lens on the light-transmitting substrate.

11. The backlight source according to claim 1, wherein each light-emitting unit is configured to emit white light.

12. The backlight source according to claim 11, wherein at least one light-emitting unit comprises sub light-emitting units of different colors.

13. The backlight source according to claim 1, wherein a ratio of a thickness of the light-transmitting substrate to a largest dimension of the second lens in a direction perpendicular to the light-transmitting substrate ranges from 8 to 20.

14. The backlight source according to claim 1, wherein the first lens comprises a plano-convex lens and the second lens comprises a plano-convex lens, and a plane of the first lens and a plane of the second lens both face the light-transmitting substrate.

15. The backlight source according to claim 14, wherein the first lens and the second lens each comprise a spherical lens.

16. The backlight source according to claim 15, wherein a ratio of a radius of curvature of the first lens to the first dimension ranges from 0.4 to 0.6, and a ratio of the first dimension to a largest dimension of the first lens in a direction perpendicular to the light-transmitting substrate ranges from 1.5 to 6.

17. The backlight source according to claim 15, wherein a ratio of a radius of curvature of the second lens to the second dimension ranges from 0.4 to 0.6, and a ratio of the second dimension to a largest dimension of the second lens in a direction perpendicular to the light-transmitting substrate ranges from 2 to 7.

18. The backlight source according to claim 13, wherein a refractive index of the first lens is greater than a refractive index of the light-transmitting substrate, and/or a refractive index of the second lens is greater than a refractive index of the light-transmitting substrate.

19. (canceled)

20. The backlight source according to claim 1, wherein an angle of light emitted from the backlight source is in a range of ta degrees, and a is not greater than 5.

21. A display device, comprising a display panel and the backlight source according to claim 1, wherein the display panel is disposed on a light-exit side of the backlight source;
the display panel comprises a plurality of sub-pixels, a maximum size of each sub-pixel in the direction parallel to the light-transmitting substrate is a fourth dimension, and a distance between adjacent first lenses is less than the fourth dimension.

22. (canceled)
